(19) United States
(12) Patent Application Publication
(10) Pub. No.: US 2026/0079339 A1
(43) Pub. Date: Mar. 19, 2026

(54) STRUCTURED SUBSTRATE, METHOD FOR MANUFACTURING THE STRUCTURED SUBSTRATE, AND USE OF THE STRUCTURED SUBSTRATE

(71) Applicants: Schott AG, Mainz (DE); SCHOTT Primoceler Oy, Tampere (FI)

(72) Inventors: Oliver Sohr, Mainz (DE); Sebastian Leugner, Mainz (DE); Jens Ulrich Thomas, Mainz (DE); Antti Määttänen, Tampere (FI)

(73) Assignees: Schott AG, Mainz (DE); SCHOTT Primoceler Oy, Tampere (FI)

(21) Appl. No.: 19/108,054

(22) PCT Filed: Aug. 17, 2023
(86) PCT No.: PCT/EP2023/072691

§ 371 Date: Feb. 28, 2025

(30) Foreign Application Priority Data
Aug. 29, 2022 (EP) 22192686.8

(51) Int. Cl. G02B 27/00; G02B 5/20; G21K 1/10

(52) U.S. Cl. CPC G02B 27/0018; G02B 5/20; G21K 1/10

(57) ABSTRACT

The invention relates to a structured substrate, preferably for applications in micro systems technology, such as for micro optical systems, comprising: a planar substrate, preferably comprising glass material, and having two opposing planar surfaces, at least one through-hole extending through the material of the planar substrate forming an inner wall surface surrounding the through-hole and connecting the two opposing planar surfaces, and a light absorbing and/or reflecting coating covering at least some areas of the inner wall surface of the through-hole. The invention further relates to method of manufacturing said structured substrate and to use of said structured substrate.

### CROSS-REFERENCE TO RELATED APPLICATIONS

This application is a national stage entry under 35 U.S.C. § 371 of International Patent Application No. PCT/EP2023/072691 entitled “STRUCTURED SUBSTRATE, METHOD FOR MANUFACTURING THE STRUCTURED SUBSTRATE, AND USE OF THE STRUCTURED SUBSTRATE” and filed on Aug. 17, 2023, which is incorporated in its entirety herein by reference. International Patent Application No. PCT/EP2023/072691 claims priority to European Patent Application No. 22192686.8 filed on Aug. 29, 2022, which is incorporated in its entirety herein by reference.

### BACKGROUND OF THE INVENTION

### 1. Technical Field of the Invention

The invention relates to a structured substrate, preferably for applications in micro systems technology, such as for micro optical systems.

### 2. Description of the Related Art

In microsystem technology, multiple wafers or substrates are often stacked on top of each other to form layered systems, for example to manufacture micro-optics. On a wafer level typically several hundred optical devices are fabricated on each wafer. For more complex optical systems, e.g. imaging optics for smartphones, several of such functional wafers are combined in a layered system. In a dicing step, the single devices are hence obtained. Often, such layered systems also include spacer wafers or spacer substrates to provide desired distances between the functional layers which comprise optical elements. Such spacer wafers are flat glass-wafer of a defined thickness, that provide a multitude of through-holes, which have at least the diameter of the individual optical elements of the functional wafers. However, depending on the surface of the through holes, undesired reflections, contrast reduction, ghosting or other disturbances may occur in the final devices.

When manufacturing such microsystems, the alignment of multiple wafers or substrates with respect to each other is critical to ensure the functionality of the micro-optical devices. For such alignment of wafers or substrates, printed or ablated surface markings are often used. However, such near-surface markings may have the disadvantage that parallax errors can occur. Another option is to use through-holes in the wafers or substrates as alignment marks or fiducials. However, pattern recognition of such through-holes is challenging due to lower contrast of the through-hole markers. Misalignment of lenses with respect to each other is detrimental to imaging properties. The more compact the micro-optical system is, e.g. with high refractive index lenses, the tighter the tolerances.

### SUMMARY OF THE INVENTION

An object of the invention is thus to reduce stray light, reflections, ghosting or other disturbances at spacer substrates in layered micro-optics, to increase contrast, and to optimize the assembly of microsystems in particular by improving pattern recognition of through-holes.

To solve this objective, a structured substrate is disclosed, preferably for applications in micro systems technology, such as for micro optical systems.

The structured substrate comprises a planar substrate having two opposing planar surfaces. The planar substrate may comprise brittle material, for example glass, ceramics, glass ceramics or the like, as is detailed further below.

The structured substrate further comprises at least one through-hole extending through the material of the planar substrate forming an inner wall surface surrounding the through-hole and connecting the two opposing planar surfaces.

Further, the structured substrate comprises a coating covering at least some areas of the inner wall surface of the through-hole, wherein the coating is light absorbing and/or light reflecting.

For alignment uses, vertical or almost vertical walls are preferred. Thus, in some embodiments of the invention, the angle of the inner wall surface to the planar surface may be 90°+/−1°, preferably +/−0.5°, more preferably +/−0.25°.

However, for other uses, such as for example beam traps, conical designs may also be employed. Thus, in some embodiments of the invention, the at least one through-hole is conical so that its diameter decreases or increases from one planar surface to the other planar surface of the substrate. Preferred angles of the conical shape are in the range of from 0.5° to 15°, more preferably from 1° to 12°, even more preferably from 2° to 10° and most preferably from 4° to 8°. The angle refers to the angle of the inner wall to the normal of the plane defined by the planar surfaces of the substrate.

Further, the at least one through hole may have an hourglass-shape so that its diameter decreases from each of the planar surfaces towards a central portion having a smallest diameter. Each of the two conical sections of the hourglass shape may have an angle in the range of from 0.5° to 15°, more preferably from 1° to 12°, even more preferably from 2° to 10° and most preferably from 4° to 8°. The two conical sections of the hourglass shape may have the same angle. Alternatively, different angles are chosen for each of the two conical sections.

Preferably, the angle of a central axis of the at least one though-hole to the planar surface of the substrate is arranged to be perpendicular to the planar surface so that the angle of the central axis of the through-hole to the planar surface may be 90°+/−1°, preferably +/−0.5°, more preferably +/−0.25°. Alternatively, the through-hole may be configured to be angled with respect to the normal defined by the planar surface of the substrate so that the angle of the central axis of the through-hole to the normal defined by the planar surface may be in the range of from larger than 0° to 15°, preferably from 1° to 12° and more preferably from 5° to 10°. For example, a through-hole array used to suppress stray light incident on an x-ray detector can consist of an array of holes, where each row or each set of rows of through holes have a different inclination towards the surface normal: e.g., the arrangement may include 5 rows of 0° holes, 5 rows of 1° holes, and further sets of rows until a final set of 5 rows of 10° holes is reached. Such a filter would thus offer a fan-like ensemble of through holes.

Generally, the planar substrate may have a thickness, i.e. a dimension extending from one planar surface to the other planar surface, which is between 20 μm and 8 mm, preferably between 50 μm and 4 mm, more preferably between 100 μm and 3 mm and most preferably between 250 μm and 1 mm.

The through-hole extending through the material of the planar substrate may define a diameter, which preferably is the smallest dimension of the through-hole parallel to the plane of the planar substrate.

In some embodiments of the invention, the through-hole may have a diameter which is between 0.3 μm and 10 mm. Such diameters, diameters in the range of 5 μm to 10 mm or larger diameters in the mm range may for example be preferred for optical cavities, e.g. for reducing stray light in micro-optics.

In some embodiments of the invention, the through-hole may have a diameter which is between 0.3 μm and 300 μm. Such diameters may be preferred for alignment purposes, and may preferably be selected so that the structure used for alignment completely fills the field of view of the microscope optics (e.g. up to approx. 300 μm).

An aspect-ratio may be defined as the ratio between the diameter of the through-hole and the thickness of the planar substrate.

Such aspect-ratio may, for example, be between 0.000075 and 17.5, preferably between 0.0001 and 10, more preferably between 0.00015 and 5, more preferably between 0.0003 and 2, more preferably between 0.001 and 1.

One may consider the inner wall surface of the through-hole before being coated. It may be preferred if such roughness is in the range of the wavelength of the light used, for example in the UV range, VIS range, NIR range.

In some embodiments of the invention, the inner wall surface has an arithmetic average roughness between 0.1 μm and 2 μm, preferably between 0.2 μm and 1 μm, more preferably between 0.4 μm and 1 μm.

One may also consider the roughness of the through-hole after being coated, i.e. the roughness of the coating itself. It is noted that the roughness before and after being coated may depend on the coating technique and parameters. For example with atomic layer deposition (ALD), the roughness of the surface may be retained, in particular if very thin ALD layers are deposited. In case of thicker layers, for example with thicknesses of greater than 250 nm, or with other coating techniques, the original roughness of the inner wall may be reduced.

In some embodiments of the invention, the coating may have an arithmetic average roughness between 0.05 μm and 2 μm, preferably between 0.1 μm and 1 μm, more preferably between 0.2 μm and 0.5 μm.

The coating may have a thickness between 5 nm and 5 μm, preferably between 15 nm and 1000 nm, more preferably between 50 nm and 500 nm.

Generally, the inner wall of the through-hole may be fully or partially coated.

In some embodiments of the invention, the coating covers at least 10%, preferably at least 50%, more preferably at least 90%, most preferably the entire area, of the inner wall surface.

In some embodiments of the invention, the inner wall surface is partially free of the coating, in particular at least 10% along the direction of the thickness of the substrate.

One or both of the planar surfaces of the substrate may be free of the coating.

One or both of the planar surfaces may be polished. In some embodiments, one or both of the planar surfaces may have an RMS roughness of less than 10 nm, preferably of less than 5 nm, more preferably of less than 1 nm, more preferably of less than 0.5 nm, more preferably of less than 0.1 nm. Such surface roughness may advantageously be achieved without additional effort by polishing the surface or surfaces. Such low roughness may be particularly beneficial when stacking substrates on top of each other to form layered systems. Thus, the step of joining layers in the production may be optimized. Smaller RMS roughness may lead to better contact bonding, sprueing and/or optical manufacturing tolerances.

Preferably, the total thickness variation (TTV) of the substrate is lower than 20 μm, more preferred lower 10, most preferred 5 μm.

If the coating is configured to be light absorbing, a parameter of interest may be the absorption coefficient or extinction coefficient of the coating.

In some embodiments of the invention, the coating may have an absorption coefficient a and/or an extinction coefficient κ for at least one wavelength λ0 within the range of 250 nm to 1600 nm, preferably within the range of 400 nm to 750 nm, more preferably for all wavelengths within one of said ranges, of at least 0.01, preferably at least 0.05, more preferably at least 0.1.

The complex refractive index may be written as n=n−iκ, the extinction coefficient being the imaginary part, having a value κ. The absorption coefficient may be written as α=4πκ/λ0 with λ0 being the vacuum wavelength. Accordingly, the penetration depth, i.e. the distance after which the intensity is reduced by a factor of 1/e, is δp=1/α=λ0/4πκ.

In some embodiments of the invention, the coating may have an absorption and/or extinction coefficient for at least one wavelength within the range of 250 nm to 1600 nm, preferably within the range of 400 nm to 750 nm, more preferably for all wavelengths within one of said ranges, such that over the thickness of the planar substrate a damping of 20 dB is achieved.

An absorption or extinction coefficient as defined above may in the VIS spectrum may for example be preferred for alignment purposes.

In some embodiments of the invention, it may be envisaged that the coating is configured to be light reflecting, in particular for a given design wavelength or wavelength range. In such a configuration, the coating may have a reflectance of more than 60% , preferably of more than 80%, more preferably of more than 90%, particularly preferably more than 95%, even more preferably more than 99% and most preferably more than 99.9%. An absorbent and/or reflective coating may for example be in the UV-NIR spectrum.

If the coating is configured to be mainly light reflecting, it is preferred that the coating has no or only a small light absorption, in particular for a given design wavelength or wavelength range. Preferably, the light absorption of a reflecting coating is less than 3%, more preferably less than 1%, even more preferably less than 0.1% and most preferably less than 0.001%.

Likewise, if the coating is configured to be mainly light absorbing, it is preferred that the coating has no or only a small amount of light reflection, in particular for a given design wavelength or wavelength range. Preferably, the light reflection of a light-absorbing coating is less than 3%, more preferably less than 1%, even more preferably less than 0.1% and most preferably less than 0.001%.

The design wavelength range is, for example a range of from 250 to 1600 nm, or the visible light range of from 400 nm to 750 nm.

The coating may generally comprise or consist of a metal, metal nitride, metal carbide, or metal oxide. Metallic materials may in some cases be preferred, followed by metal nitrides and carbides. It is noted that the material may be selected to be compatible with the processes as outlined below.

In some embodiments of the invention, the coating may comprise at least one of the following materials: Al2O3, B2O3, Co2O3, Cr2O3, CuO, Fe2O3, Ga2O3, HfO2, In2O3, MgO, Nb2O5, NiO, Pd, Pt, Al, Ag, Mo, W, SiO2, SnO2, Ta2O5, TiO2, TaNx, (Ta, Al)N, TiCrOx, (Ti, Al)N, (Ti, Al)C, TiC, AlC, AlN, TiN, VO2, WO3, ZnO, (Al, Zn)O, ZnS, ZnSe, ZrO2, Rare earth (RE) oxides, Sc2O3, Y2O3, Carbon, Carbonblack, Ca10(PO4)6(OH)2), Polyimides, PMDA-ODA, PMDA-DAH, 3-aminopropyltrimethoxysilane coupling agent.

The coating may be configured as a multilayer structure comprising several layers. A particular example is a coating configured to be reflective which may be constructed as a dielectric mirror comprising a plurality of alternating layers having a different index of refraction.

As already described, the coating may be applied by means of one or more of several processes. For example, the light absorbing coating may be deposited by means of vacuum deposition, preferably physical vapor deposition (PVD) or chemical vapor deposition (CVD), preferably atomic layer deposition (ALD) or plasma-enhanced chemical vapor deposition (PECVD).

As mentioned above, the planar substrate may comprise or consist of glass, fused silica, ceramics, glass-ceramics and/or crystals, e.g. sapphire. For example Zerodur® may be employed. In certain embodiments, polymer or plastic materials might also be used.

In preferred embodiments, the planar substrate comprises glass material, ceramic material, glass ceramic material and/or crystalline material, e.g. sapphire.

The planar substrate may comprise at least one of the following components: SiO2 content of at least 30 wt %, preferably at least 50 wt %, more preferably at least 80 wt %.

In a further embodiment of the invention, the structured substrate may comprise a plurality of through-holes extending through the material of the planar substrate, each forming an inner wall surface surrounding the respective through-hole and connecting the two opposing planar surfaces of the planar substrate.

In such a plurality of through-holes, each of the trough-holes can have an identical configuration. Alternatively, the all or groups of more than one through holes may have different configurations in which, for example, the angle of the inner wall, the angle of the central axis, the diameter of the through hole or more than one of said parameters is varied. For example, the angle of the central axis may be varied from one through hole to a neighboring through hole in order to create a fan-like arrangement of through-holes.

For some uses of the of the structured substrate, such as for example as a spatial light filter element, the structured substrate may comprise an array of through holes. In such a configuration, preferably identically configured through-holes are arranged in a regular two-dimensional grid pattern. Such a pattern can be configured as a square or rectangular arrangement having a row and column structure having equal distances between the rows and columns. Other configurations include triangular or hexagonal patterns.

A distance between two rows and/or between two columns is, for example, chosen in the range of from 2 μm to 1 mm, preferably from 20 μm to 400 μm, more preferably from 100 to 300 μm. Preferably, the distance or pitch P between two neighboring through holes is chosen in relation to the diameter W of the through-hole at the planar surface such that the pitch P is larger than the diameter W, preferably, the pitch is chosen such that P>1.1 W, more preferably P>1.5 W and most preferably P>2 W.

An example application for such a spatial filter element is a stray light filter, for example in an x-ray detector. In such a spatial filter application, the coatings properties are preferably chosen such that the coating is light absorbing and has no or only a negligible amount of reflection.

The at least one through-hole or at least one of the plurality of through-holes may have a cross section which is non-mirror-symmetrical and/or non-circular, preferably comprises one or more rectangular portions, for example is L-shaped.

Such shapes may be preferred for substrate alignment. Generally, The at least one or plurality of through-holes may be designed such that (i) displacements are detectable, (ii) rotations are detectable, and/or (iii) a wrong orientation (top side on top side vs. bottom side on top side) is detectable. In particular, number, size and/or shape of the at least one or plurality of through-holes may be designed such as to ensure these conditions. One example is an L-shaped through-hole. However many other designs that will also be suitable.

The invention also relates to a method for manufacturing a structured substrate, preferably as outlined above.

The method comprises providing a planar substrate, preferably comprising glass material, and having two opposing planar surfaces, wherein at least one through-hole is inserted or extends through the material of the planar substrate so as to form an inner wall surface surrounding the through-hole and connecting the two opposing planar surfaces.

The method also comprises depositing a light absorbing and/or light reflecting coating onto the planar substrate covering at least some areas of the inner wall surface of the through-hole.

The method may also comprise treating, preferably polishing, one or both of the planar surfaces of the planar substrate to remove coating covering the planar surfaces, so that the planar surfaces are free of the coating. Polishing may be applied, so that a RMS roughness of less than 10 nm, preferably less than 5 nm, more preferably less than 1 nm is achieved. For polishing it is referred to chapter 8 “novel polishing methods”, pages 319-352 in Materials Science and Technology of Optical Fabrication, John Wiley & Sons, 16.10.2018.

The method may comprise inserting the at least one through-hole in the material of the planar substrate. In particular at least one thin filament or filamentary damage may be introduced into the material of the substrate by means of a laser process. Such filament may have a diameter of approx. 0.1-0.5 μm, e.g. 0.3 μm. Preferably, in a further step, such filament may then be expanded by etching. Moreover, multiple filaments may be introduced. By placing multiple filaments close together, practically any shape and size of through-hole can be created. It is noted that if only small through-holes are desired, etching can also be omitted.

If the structured substrate comprises more than one through-hole, the relative positional accuracy of two neighboring through holes, with respect to the center of said through-holes, is preferably better than 2%, more preferably better than 1% and most preferably better than 0.1%. An absolute positional accuracy is preferably in the range of +/−0.5 μm. If a regular pattern, such as a row and column pattern is used, it is preferred that an average deviation from the set pitch is less than 0.2 μm, preferably less than 0.02 μm.

Such a high accuracy may, for example, be achieved by means of the proposed combined laser and etching method described herein.

With respect to the method of coating, the light absorbing and/or light reflecting coating may in some embodiments of the invention be deposited onto the planar substrate by means of vacuum deposition, preferably physical vapor deposition (PVD) or chemical vapor deposition (CVD), preferably atomic layer deposition (ALD) or plasma-enhanced chemical vapor deposition (PECVD).

The invention further relates to the use of a structured substrate, preferably as outlined above, for aligning the structured substrate with respect to another element, wherein, preferably, the structured substrate is observed in top view on one of its planar surfaces so that the coating, which covers the inner wall surface, is visible in side view forming a contour surrounding the through-hole, and wherein, preferably, a position of said contour surrounding the through-hole is compared to a defined position on the another element.

Such defined position may for example be a marking on the another wafers, which comprise functional elements such as micro-optics, light sensors or emitters.

It is noted that the observing in top view on one of its planar surfaces need not be performed directly on the surface, but can also be performed through other substrates or layers, in particular in micro-systems comprising multiple layers.

In one particular embodiment the another element may be a second structured substrate, preferably as outlined above, and the structured substrate and the second structured substrate are positioned on top of each other such that one of the planar surfaces of the structured substrate faces one of the planar surfaces of the second structured substrate, and both the structured substrate and the second structured substrate are observed in top view so that simultaneously a contour surrounding the through-hole of the structured substrate and a second contour surrounding the through-hole of the second structured substrate is formed, and a position of said contour is compared to a position of said second contour.

In the use of the structured substrate, the positional error between said contour surrounding the through-hole and said defined position on the other element, preferably in the x-y-plane, may be reduced to less than 2 μm, preferably to less than 0.1 μm, even more preferably to less than 50 nm.

Also, the positional error between said contour surrounding the through-hole and said defined position on the other element, preferably in the z-direction, more preferably over the entire area of the substrate, may be reduced to less than 20 μm.

It is also conceivable that the structured substrate and/or the other element comprises markings which are introduced by ion beam treatment, wherein said markings preferably are used for aligning and/or assisting aligning the structured substrate with respect to another element.

The invention further relates to the use of a structured substrate as outlined above for manufacturing a micro system, preferably a micro optical system.

Preferably, the micro optical system comprises multiple layers and at least one of said layers is formed as the structured substrate.

For example, three layers may be stacked, wherein the middle one may be a structured substrate as outlined above. Such middle layer may in particular be a spacer layer. The other or outer layers may be provided with refractive or diffractive micro-optics. In this example two outer micro-optics layers and the inner spacer layer are preferably aligned with each other as outlined above.

Preferably, stray light in the micro system is reduced by means of the coating, in particular a light absorbing and non-reflecting coating, covering the inner wall surface of the through-hole extending through the material of the planar substrate of the structured substrate.

The invention further relates to an assembly comprising a layer structure of two or more layers, wherein at least one of the layers is a structured substrate as outlined above.

The assembly may comprise at least one further substrate layer having markings corresponding to the through holes of the structured substrate, wherein the markings of the further substrate and the through holes of the structured layer are aligned, preferably as outlined above.

The assembly may comprise at least three layers, having in this order a first micro-optic layer, a structured substrate as outlined above, and a second micro-optic layer.

Such three layers may be considered to form a unit cell and more than three layers, for example five layers, may also be stacked with two such unit cells, wherein the middle layer belongs to both unit cells.

The invention further relates to a beam trap comprising a structured substrate as described above and a further substrate connected thereto, said further substrate comprising at least one blackened and/or roughened surface.

Generally, the invention is at least suitable for wafer bonding, stacked transparent components, micro-optics, wafer level alignment, stray light suppression, glass circuit boards, micro sensors, such as wafer level or pressure sensors, microfluidics, LIDAR sensors, sensor arrays, wafer level packaging.

### BRIEF DESCRIPTION OF THE DRAWINGS

The invention is described in more detail below with reference to the figures.

FIG. 1 shows side views of processing steps (a)-(d) for manufacturing a structured substrate,

FIG. 2a shows a side view of two stacked structured substrate,

FIG. 2b shows a further side view in which the two stacked structured substrates are illuminated,

FIG. 2c shows a top view of the two stacked structured substrates,

FIG. 3 shows a top view of a substrate having an L-shaped through-hole,

FIG. 4 shows schematically the alignment of two L-shaped through-holes with respect to each other,

FIG. 5 shows side views of processing steps (a)-(d) for manufacturing a layered assembly comprising a structured substrate and optical substrates,

FIG. 6 shows a side view of a structured substrate having holes arranged in a fan-like manner,

FIG. 7 shows a perspective view of a structured substrate having a plurality of through holes arranged in a regular pattern,

FIG. 8 shows a perspective view of a cut structured substrate having a plurality of through holes arranged in a regular pattern, and

FIG. 9 shows a sideview of a structured substrate having a plurality of hourglass-shaped through-holes.

### DETAILED DESCRIPTION OF THE INVENTION

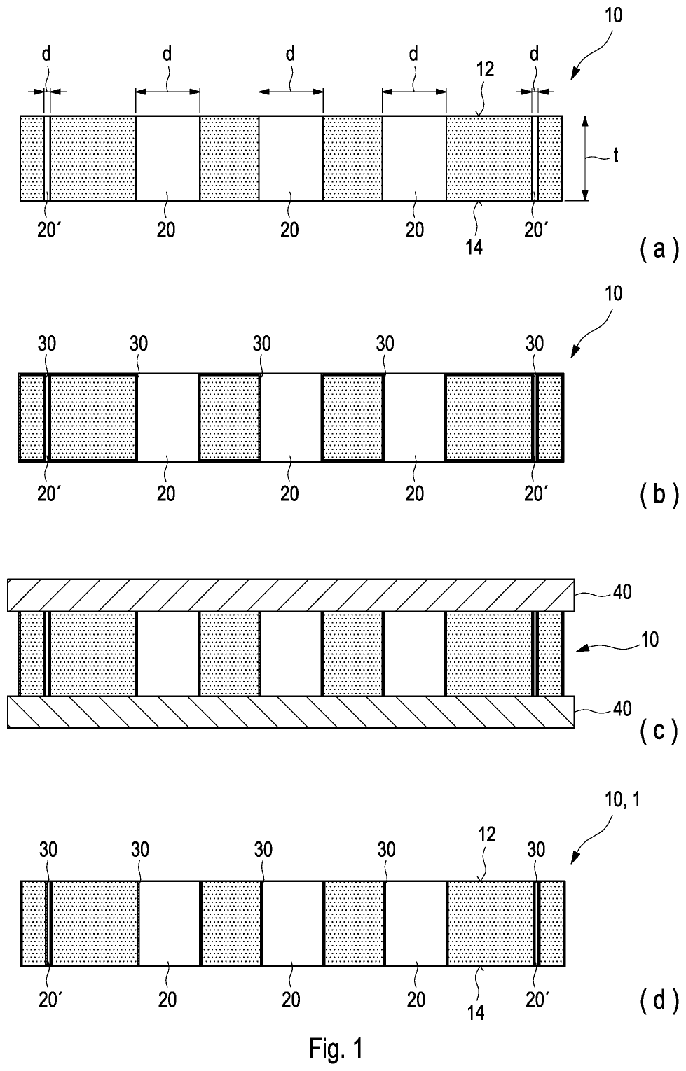

FIG. 1 shows an example of a process for manufacturing a structured substrate 1, wherein the process comprises the steps (a)-(d).

In step (a), a planar substrate 10 is provided, wherein the planar substrate comprises two opposing planar surfaces 12, 14 and multiple through-holes 20, 20′ extending through the thickness t of the planar substrate.

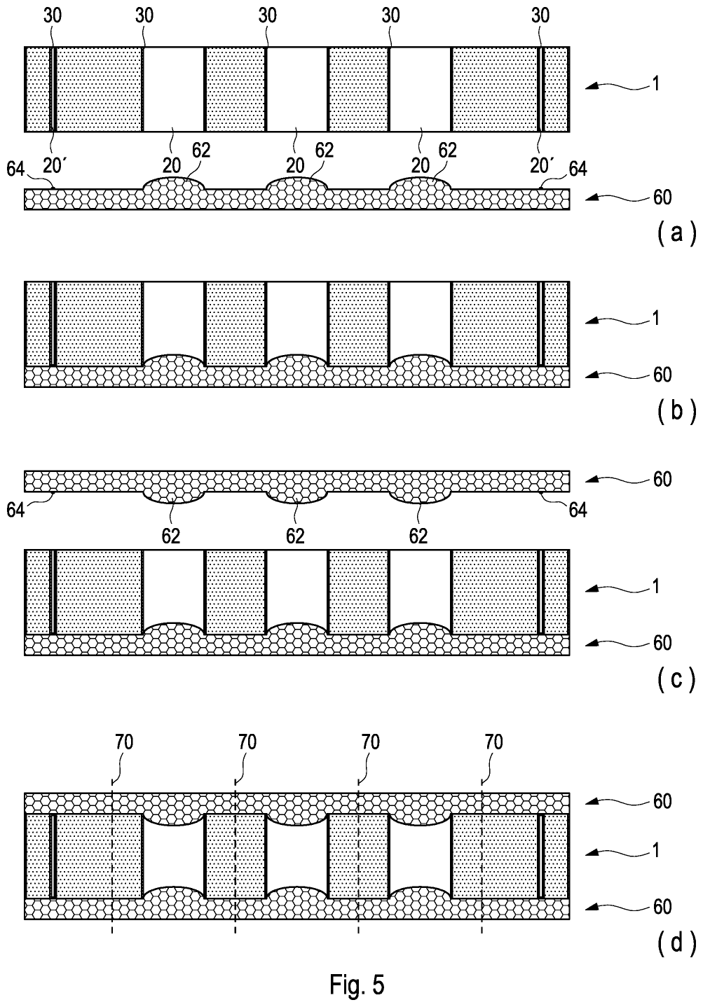

Some of the through-holes 20 have a larger diameter d than other through-holes 20′. The through-holes 20 having the larger diameter d may be designed to accommodate optical elements 62 (see FIG. 5), while the through-holes 20′ having the smaller diameter d may be used for aligning multiple substrates which are stacked on top of each other.

In step (b), a light absorbing and/or light reflecting coating 30 is deposited onto the planar substrate so as to cover at least some areas of the inner wall surfaces of the through-hole 20, 20′. Such coating may for example have a thickness between 5 nm and 5 μm and may be configured as absorbing and/or reflecting in particular wavelength ranges, such as for example the UV-NIR range. The coating may be applied for example by atomic layer deposition (ALD), however other coating techniques are also possible, such as ion beam coating or liquid coating. In this particular example, the light absorbing and/or light reflecting coating 30 not only covers the inner wall surfaces of the through-hole 20, 20′, but also covers the two opposing planar surfaces 12, 14 of the substrate 10.

Thus, in step (c), the planar surfaces 12, 14 of the substrate 10 are polished to remove the coating covering the planar surfaces 12, 14, so that the planar surfaces 12, 14 are free of the light absorbing and/or light reflecting coating. The polishing can be carried out with a polishing medium 40. It is also conceivable that the planar surfaces 12, 14 are subjected to plasma etching or laser ablation to remove the coating covering the planar surfaces 12, 14. The polishing can also consist of multiple polishing steps, especially, if it used to improve the surface quality of the planar surfaces. With decreasing grain size it is possible to obtain RMS roughnesses below 1 nm or even below 0.1 nm. Additionally the polishing can be used to compensate for total thickness variations (TTV) of the wafer.

The resulting structured substrate 1 shown in (d) comprises a planar substrate 10 having multiple through-hole 20, 20′ extending through the material of the planar substrate 10 forming an inner wall surface surrounding the through-holes 20, 20′ and connecting the two opposing planar surfaces 12, 14, wherein a light absorbing and/or light reflecting coating 30 covers the inner wall surfaces of the through-holes 20, 20′.

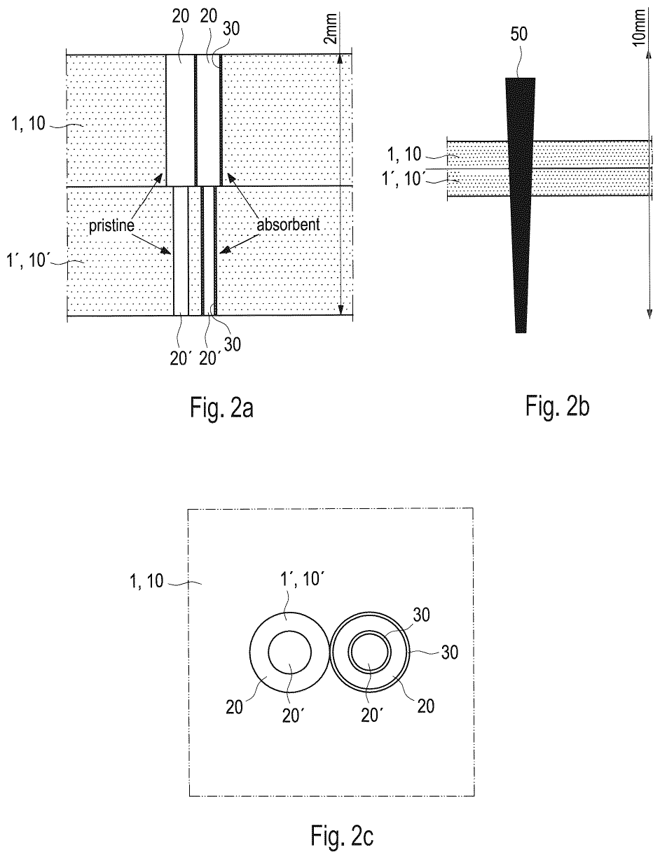

FIG. 2a shows two stacked structured substrates 1, 1′, wherein the upper substrate 1 comprises two adjacent through-holes 20 with a larger diameter and the lower substarte 1′ comprises two adjacent through-holes 20′ with a smaller diameter. The inner wall surfaces of the right through-holes in each of the two substrates are covered with a light absorbing and/or light reflecting coating 30.

FIG. 2b shows an illumination setup for directing light on the structured substrates 1, 1′ and through the through-holes within the substrates.

FIG. 2c shows the structured substrates 1, 1′ observed in top view one of its planar surfaces so that the light absorbing and/or light reflecting coating 30, which covers the inner wall surface of the right through-holes becomes visible in side view forming a contour surrounding the through-holes. As can be seen, the light absorbing and/or light reflecting coating 30 significantly improves the detectability of the through-holes acting as fiducials, thus optimizing in particular the assembly of microsystems.

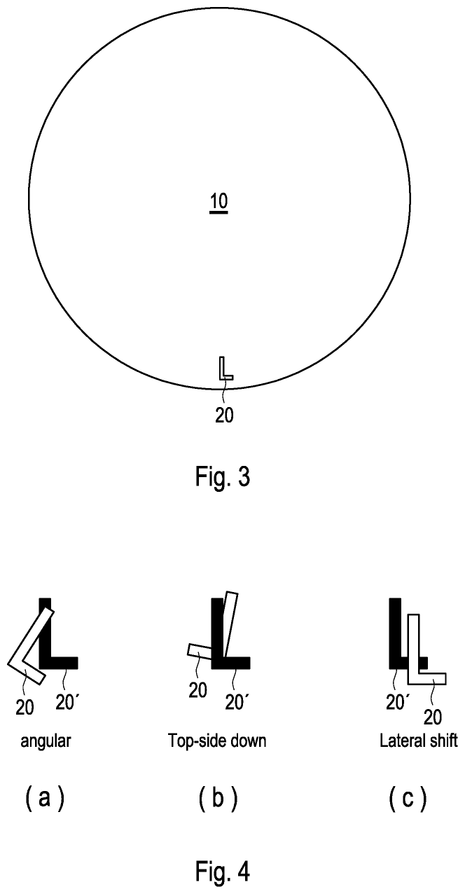

FIG. 3 shows a substrate 10 having an L-shaped through-hole 20 forming a non-mirror-symmetrical alignment marker to detect different configurations of substrates with respect to each other. As shown in FIG. 4, rotations between two through-holes 20, 20′ (and corresponding substrates) are detectable (a), wrong orientations (top side on top side vs. bottom side on top side) are detectable (b), and displacements are detectable (c).

FIG. 5 shows an example of a process manufacturing a layered assembly comprising a structured substrate 1 and two optical substrates 60, wherein the process comprises the steps (a)-(d).

In steps (a) and (b) the lower optical substrate 60 is being aligned with the structured substrate 1, which corresponds to the structured substrate 1 of FIG. 1(d). To this end, the optical substrate 60 comprises alignment markers 64, which are for example printed or laser ablated in the surface of the material. These alignment markers 64 are brought into alignment with smaller outer through-holes 20′ of the structured substrate 1. Thereby, the optical elements 62 of the optical substrate 60 are aligned with the larger inner through-holes 20 of the structured substrate 1 so that they can be embedded therein when the optical substrate 60 and the structured substrate 1 are connected.

In steps (c) and (d) another optical substrate 60 is aligned and connected with the structured substrate 1 in a similar manner from above resulting in a micro-optical assembly comprising three substrate layers. In a further singulation step, the micro-optical assembly can be severed along the dividing lines 70.

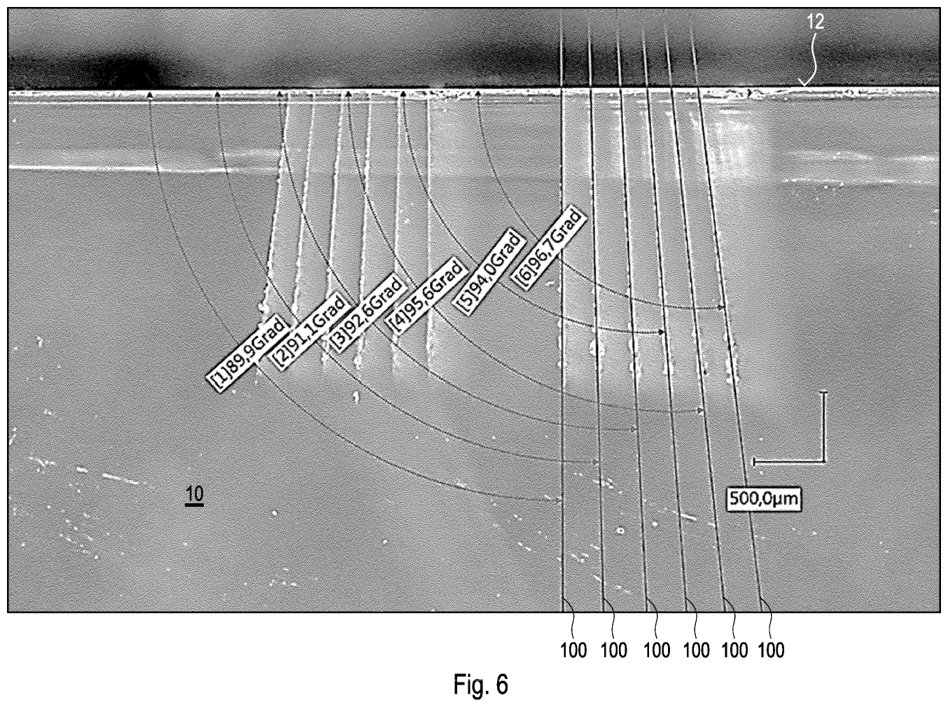

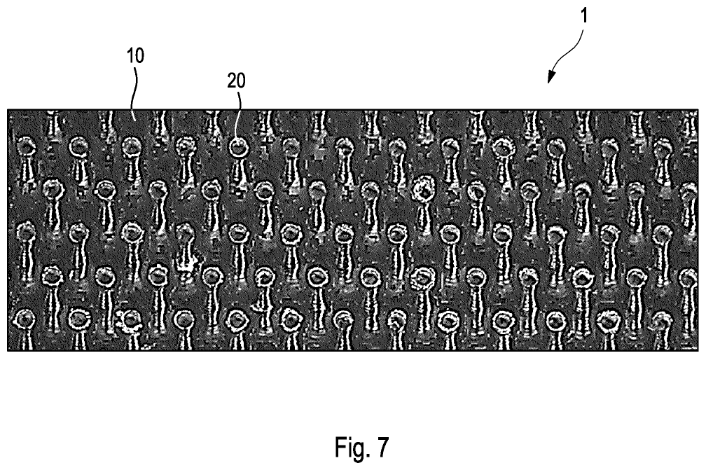

FIG. 6 is a microscope image showing a side view of a substrate 10 having a plurality of holes arranged in a fan-like manner. Each of the holes has a central axis, which has been marked with reference numeral 100. The angle between said central axis and a surface normal of the planar surface 12 of the substrate 10 varies to form the fan-like arrangement. Note that in this figure, the angles beta are measured with respect to the surface. The angles with respect to surface normal are alpha=beta−90°. In the state depicted in FIG. 6, the holes are not yet configured as through holes 20 as shown for example in FIGS. 7, 8 and 9, but as blind holes. Through holes 20 may be obtained by thinning the substrate 10, for example by grinding and polishing.

FIG. 7 is a microscope image showing a perspective view of a structured substrate 1 having a plurality of through holes 20 in the substrate 10 arranged in a regular pattern. The shown through holes 20 have identical configurations and are arranged in a pattern of rows, wherein the through holes 20 have equal spacing within a row, but two neighboring rows are offset.

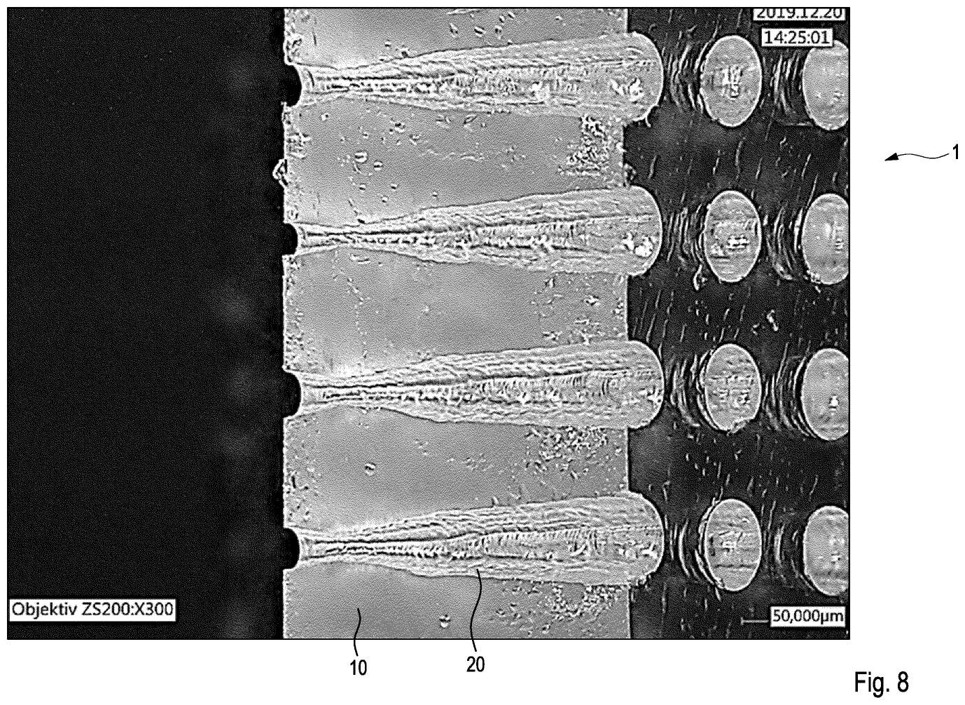

FIG. 8 is a microscope image showing a perspective view of a cut structured substrate 1 having a plurality of through holes 20 arranged in a regular pattern. The shown through holes 20 have identical configurations and are arranged in a pattern of rows, wherein the through holes have equal spacing within a row, but two neighboring rows are offset.

The shape of each of the through holes 20 is in this embodiment an hourglass shape so that the diameter of the through holes 20 is largest on the planar surfaces and decreases towards a minimal diameter.

The structured substrates 1 of FIGS. 7 and 8 are in particular useful for optical filters, in particular spatial filters. An example of such an application is a stray light filter in an x-ray detector.

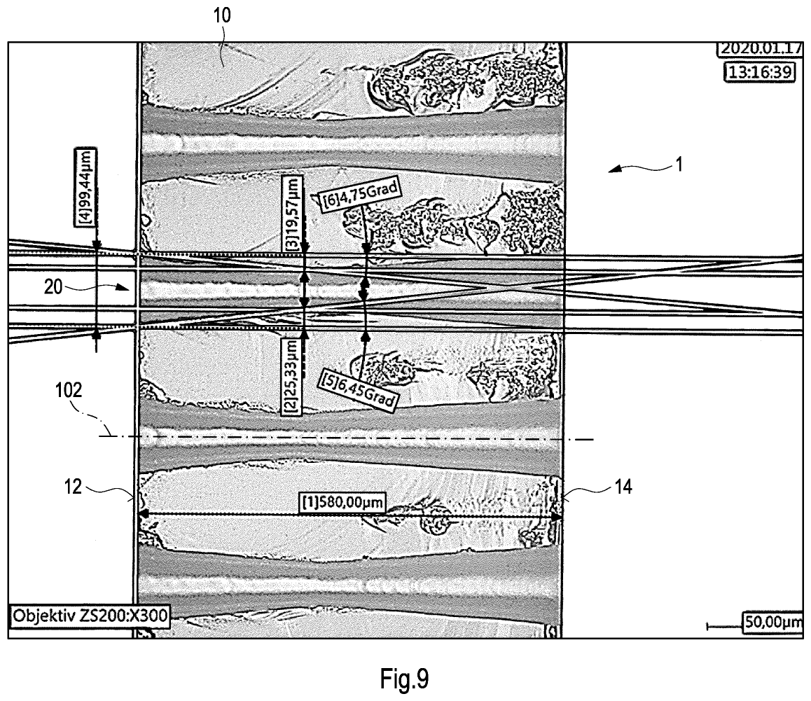

FIG. 9 is a microscope image showing a sideview of a further embodiment of a structured substrate 1 having a plurality of hourglass-shaped through-holes 20 obtained by means of a combined laser and etching process. The through holes 20 are in this example arranged in a regular pattern of rows and columns with equal spacing between the rows and columns.

FIG. 9 depicts a cut substate 10 having a thickness of 580 μm in a sideview so that the structure of the hourglass-shaped through holes 20 is visible. The through holes 20 have two conical sections wherein the diameter of the hole in each of the sections is largest at the planar surfaces 12, 14 of the substrate 10 and decreases towards a minimum diameter located between the two conical sections. In the depicted example, the two conical sections are not configured equal so that one of the sections is larger than the other. Alternatively, it is possible to configure the hourglass shape such that two equal conical sections are formed. In the depicted example, a central axis 102 of the through holes 20 is perpendicular to the planar surfaces 12, 14 of the substrate 10.

In the example of FIG. 9, a first conical section abutting a first planar surface 12 of the substrate 10 has a diameter of 99.44 μm at the first planar surface 12. The diameter of the first conical section decrease until a minimum diameter is reached. The angle of the conical walls was in this example set to 5.5°, but due to small variations of the process, the angle varies from about 4.75° to about 6.45°. However, as the process is applied identically to each of the through-holes of the plurality of through-holes, the variation of the shape within the plurality of through holes is less.

1-23. (canceled)

24. A structured substrate, comprising:
a planar substrate having two opposing planar surfaces;
at least one through-hole extending through a material of the planar substrate forming an inner wall surface surrounding the at least one through-hole and connecting the two opposing planar surfaces; and
a coating covering at least some areas of the inner wall surface of the at least one through-hole, wherein the coating is light absorbing and/or light reflecting, wherein one or both of the two opposing planar surfaces are free of the coating; wherein the inner wall surface has an arithmetic average roughness between 0.1 μm and 2 μm and/or the coating has an arithmetic average roughness between 0.05 μm and 2 μm.

25. The structured substrate of claim 24, wherein at least one of the following is satisfied:
an angle of the inner wall surface to the two opposing planar surfaces and/or an angle of a central axis of the at least one through-hole to the two opposing planar surfaces is 90°+/−1°;
the at least one through-hole is conical so that its diameter decreases or increases from one of the two opposing planar surface to the other one of the two opposing planar surfaces of the planar substrate; or
the at least one through-hole has an hourglass-shape so that its diameter decreases from each of the two opposing planar surfaces towards a central portion having a smallest diameter.

26. The structured substrate of claim 24, wherein an angle of the inner wall surface to a normal defined by the two opposing planar surfaces is in a range of from larger than 0° to 15°;
and/or wherein an angle of a central axis of the at least one through-hole to the normal defined by the two opposing planar surfaces is in a range of from larger than 0° to 15°.

27. The structured substrate of claim 24, wherein the planar substrate has a thickness extending from one of the two opposing planar surfaces to the other one of the two opposing planar surfaces which is between 20 μm and 8 mm.

28. The structured substrate of claim 24, wherein the at least one through-hole has a diameter which is between 0.3 μm and 300 μm.

29. The structured substrate of claim 24, wherein the at least one through-hole defines an aspect-ratio being a ratio between a diameter of the at least one through-hole and a thickness of the planar substrate, which is between 0.000075 and 17.5.

30. The structured substrate of claim 24, wherein the coating has a thickness between 5 nm and 5000 nm.

31. The structured substrate of claim 24, wherein the coating covers at least 10% of the inner wall surface and/or the inner wall surface is partially free of the coating at least 10% along a direction of a thickness of the substrate.

32. The structured substrate of claim 24, wherein at least one of the following is satisfied:
one or both of the two opposing planar surfaces is polished;
one or both of the two opposing planar surfaces has an RMS roughness of less than 10 nm; or
a total thickness variation of the planar substrate is lower than 5 μm.

33. The structured substrate of claim 24, wherein at least one of the following is satisfied:
the coating has an extinction coefficient for at least one wavelength within a range of 250 nm to 1600 nm of at least 0.01;
the coating has an extinction coefficient for at least one wavelength within a range of 250 nm to 1600 nm such that over a thickness of the planar substrate a damping of 20 Db is achieved; or
the coating has a reflectance of more than 60%.

34. The structured substrate of claim 24, wherein the coating comprises at least one of the following materials: Al₂O₃, B₂O₃, Co₂O₃, Cr₂O₃, CuO, Fe₂O₃, Ga₂O₃, HfO₂, In₂O₃, MgO, Nb₂O₅, NiO, Pd, Pt, Al, Ag, Mo, W, SiO₂, SnO₂, Ta₂O₅, TiO₂, TaNx, (Ta, Al)N, TiCrOₓ, (Ti, Al)N, (Ti, Al)C TiC, AlC, AlN, TiN, VO₂, WO₃, ZnO, (Al, Zn)O, ZnS, ZnSe, ZrO₂, rare earth (RE) oxides, Sc₂O₃, Y₂O₃, carbon, carbonblack, Ca₁₀(PO₄)6(OH)2), polyimides, PMDA-ODA, PMDA-DAH, or 3-aminopropyltrimethoxysilane coupling agent.

35. The structured substrate of claim 24, wherein at least one of the following is satisfied:
the planar substrate comprises glass material, ceramic material, glass ceramic material and/or crystalline material; or
the planar substrate comprises an SiO₂ content of at least 30 wt. %.

36. The structured substrate of claim 24, wherein at least one of the following is satisfied:
the at least one through-hole comprises a plurality of through-holes extending through the material of the planar substrate, each of the through-holes forming an inner wall surface surrounding the respective through-hole and connecting the two opposing planar surfaces of the planar substrate; or
the at least one through-hole or, when a plurality of through-holes is present, at least one of the plurality of through-holes has a cross section which is non-mirror-symmetrical and/or non-circular.

37. A method for manufacturing a structured substrate, comprising:
providing a planar substrate having two opposing planar surfaces, wherein at least one through-hole extends through a material of the planar substrate so as to form an inner wall surface surrounding the at least one through-hole and connecting the two opposing planar surfaces;
depositing a coating, which is light absorbing and/or light reflecting, onto the planar substrate covering at least some areas of the inner wall surface of the at least one through-hole, wherein the inner wall surface has an arithmetic average roughness between 0.1 μm and 2 μm and/or the coating has an arithmetic average roughness between 0.05 μm and 2 μm; and
treating one or both of the two opposing planar surfaces of the planar substrate to remove coating so that one or both of the two opposing planar surfaces are free of the coating.

38. The method of claim 38, wherein the coating is deposited onto the planar substrate by vacuum deposition.

39. An assembly, comprising:
a layer structure of two or more layers, wherein at least one of the layers is a structured substrate comprising:
a planar substrate having two opposing planar surfaces;
at least one through-hole extending through a material of the planar substrate forming an inner wall surface surrounding the at least one through-hole and connecting the two opposing planar surfaces; and
a coating covering at least some areas of the inner wall surface of the at least one through-hole, wherein the coating is light absorbing and/or light reflecting, wherein one or both of the two opposing planar surfaces are free of the coating; wherein the inner wall surface has an arithmetic average roughness between 0.1 μm and 2 μm and/or the coating has an arithmetic average roughness between 0.05 μm and 2 μm.

40. The assembly of claim 39, comprising at least one further substrate layer having at least one marking corresponding to the at least one through-hole of the structured substrate, wherein the at least one marking of the at least one further substrate layer and the at least one through-hole of the structured substrate are aligned.

41. The assembly of claim 39, comprising at least three layers having in this order a first micro-optic layer, the structured substrate, and a second micro-optic layer.
